(19) United States
(12) Patent Application Publication
(10) Pub. No.: US 2022/0349729 A1
(43) Pub. Date: Nov. 3, 2022

(54) DEVICE FOR GENERATING A ROCKING MOVEMENT ON A ROCKER, IN PARTICULAR A BABY ROCKER

(71) Applicant: 1st Baby GmbH, Neumuenster (DE)

(72) Inventors: Hans-Josef REINERS, Hueckelhoven (DE); Dominik MATYKA, Berlin (DE); Christopher PAVEL, Juechen (DE)

(73) Assignee: 1st Baby GmbH, Neumuenster (DE)

(21) Appl. No.: 17/641,859

(22) PCT Filed: Sep. 10, 2020
(86) PCT No.: PCT/EP2020/075324

§ 371 Date: Mar. 10, 2022

(30) Foreign Application Priority Data
Sep. 11, 2019 (DE) 10 2019 124 467.6

(51) Int. Cl. G01D 5/14; A47D 9/02

(52) U.S. Cl. CPC G01D 5/145; A47D 9/02

(57) ABSTRACT

A device for generating a rocking movement on a rocker, in particular a baby rocker, includes a driver that can be moved by a power feeder, and drives the rocker in a repeating movement, with a sensor for determining a sensor signal that is influenced by the movement state of the rocker, with a control circuit for controlling the power feeder as a function of the sensor signal. In order to drive the rocker with the frequency of its free oscillation, the movement of the driver is clocked by the sensor signal.

### AREA OF TECHNOLOGY

The invention relates to a device for generating a rocking movement on a rocker, in particular a baby rocker, with a driver that can be moved by a power feeder and drives the rocker in a repeating movement, with a sensor for determining a sensor signal that is influenced by the movement state of the rocker, with a control circuit for controlling the power feeder as a function of the sensor signal.

### PRIOR ART

A device for generating a rocking movement of a rocker, in particular a baby rocker, is previously known from WO 2008/048959 A2. The device has a power feeder in the form of a vibration generator, which can transfer a movement to the baby rocker. A sensor is provided in the form of an accelerometer, which can be used to determine the amplitude of the oscillation transferred to the baby rocker. The measured amplitude can be used to influence the power transferred by the power feeder to the baby rocker.

U.S. Pat. No. 4,985,949 discloses a driving device for generating a rocking movement on a baby rocker, wherein a cam driven by a rotary drive engages under an edge of the baby rocker so as to impart an oscillation to the baby rocker.

### SUMMARY OF THE INVENTION

The object of the invention is to further develop a generic device in such a way that it keeps a rocker in its natural oscillation.

The object is achieved by the invention indicated in the claims. The subclaims represent not only advantageous further developments of the solution indicated in claim 1, but rather standalone solutions of the object as well.

It is initially and essentially proposed that the rocker, in particular baby rocker, baby shell, baby seat or the like, be driven with its natural frequency, so that the rocker, in particular baby rocker, baby shell or baby seat, swings with its natural oscillation. Provided for this purpose is a sensor, which picks up the oscillation of the rocker on the rocker, or generates a sensor signal that is periodic with the natural frequency. According to the invention, the movement of the driver, which acts on the rocker, is clocked with the sensor signal of the sensor. As a result, the rocker is driven with the frequency of its free oscillation. In a preferred embodiment of the invention, the sensor signal is acquired at a position of the driver on its movement path. It is here provided in particular that the sensor emits the sensor signal when the moving driver passes a predetermined point on its movement path or reaches this point. A lifting or push head can be arranged at the free end of the driver. It can exert a vertical lift. The head preferably acts on an arm or on a projection of the rocker, so as to impart a pulse in the vertically upward direction at the point of attack of the rocker. The pulse is here only triggered if the driver has reached a predetermined point on its movement path and/or is moving in an upward direction. Shortly after or at the same the point in time at which the driver has passed the sensor in an upward direction or a trigger resting on the driver has passed the sensor in an upward direction, the power feeder briefly transmits a pulse to the driver, which transmits this pulse to the rocker, so that its frictional losses, etc., can be balanced out. It can be provided that the trigger pass by the sensor two times during the movement of the driver, initially during a downward displacement of the driver, and then during an upward displacement of the driver. The control circuit is designed in such a way that the power feeder only transmits a pulse that accelerates the driver during the upward displacement of the driver. It is provided that the driver be pressed into an upper rest position by means of a tension or pressure spring, in which the driver abuts against an upper stop. A damping member can here be provided, for example in the form of an O-ring, which lies between the driver and a counter-stop surface. The driver can be displaced in a downward direction by a pressure exerted vertically downward on the free end of the driver. During use as intended, this takes place by pressing a section of the rocker, for example an arm arranged above the driver, onto a head of the driver from above. The driver is downwardly displaced together with the section of the rocker, during which the spring is tensioned. If the rocker is released, the deflection of the rocker tends to make the rocker swing freely. Along with this, the tensioned spring displaces the motion transmitter in a vertically upward direction, until the trigger passes by the sensor in an upward direction. The control circuit energizes an electromagnet, which accelerates the driver in an upward direction. The force that here results is transmitted to the rocker over the lifting path, until the driver has assumed its upper end position. Since the lifting path of the rocker arm is larger than the lift of the driver, the section of the rocker is engaged from below by the driver, for example the arm of the driver, so that the rocker can freely perform its residual oscillation. It reaches an upper dead point and swings back until it again hits the head of the driver, and displaces it back down again, until a reversal of movement takes place in the lower dead point. The trigger here runs over the sensor for a first time. Only when the trigger runs over the sensor a second time during the upward movement of the driver is a pulse once again transmitted to the rocker. Power is fed into the driver by the power feeder once the sensor has detected an upward movement of the driver. It is viewed as advantageous for the driver to have a first magnet, which is exposed to a force exerted by an electromagnet in order to generate the pulse. This can be a ring magnet or the like, in which the driver can move. According to a preferred embodiment, the sensor is a magnetic sensor. A Hall sensor is involved in particular. The trigger that interacts with the sensor is preferably a magnet, wherein the pole axis of the magnet is aligned parallel to the direction of movement of the driver, so that the direction of the magnetic field changes as the trigger passes by the sensor. Based on the direction of change in the magnetic field, the control circuit can determine whether the trigger passed by the sensor in an upward or downward direction. However, an optical sensor can also be used instead of a magnetic sensor. Several sensors can also be used to determine the direction of movement of the transmitter. In particular, the sensor involves an arrangement having one or several sensor elements, which can be used to determine the movement of the driver, for example once a trigger of the driver has reached or overrun a predetermined point on its movement path. The device according to the invention preferably has a housing with a cylindrical shape, wherein the cylindrical axis extends in the vertical direction. The section of the driver that acts on the rocker can be shaped like a mushroom. To this end, the driver can be equipped with a mushroom-shaped lift or push head. One variant of the device functions as follows: The device is placed under an arm of a rocker, in particular a baby rocker. The device can stand on the same substrate upon which the rocker also rests. The baby rocker can be a shell that has one or more rounded runners. The rocker can execute a swinging motion via the runners. Among other things, the frequency of the swinging motion depends on the mass of the child lying in the rocker. In the rest position, the arm is spaced vertically apart from the crown of the head of the device. The arm is manually pressed downward until it touches the head, and further until the head has reached its lower end position. The arm is then released. Given the deflection of the rocker, it tends to swing back. The spring acts on the driver, causing it to be upwardly displaced. The sensor determines this upward displacement. The control circuit causes the power feeder to transmit a vertically upwardly directed pulse to the driver. Accelerating the swinging motion of the rocker, the latter is transmitted to the rocker. The driver then reaches its upper end position. The motion accelerated rocker continues to swing until reaching its end oscillating position, wherein the arm of the rocker detaches from the head of the device. While swinging back, the arm again hits the head, and displaces it until into the end position. This is followed by a second period of the oscillation of the rocker driven in a natural frequency. In particular, it is provided that the rocker only be acted upon briefly by the device during its oscillation phase, for example once its oscillation has reached the lower dead point. A variant of the invention can provide that the device be fixedly secured to the rocker. The driver can then be periodically pushed off the substrate that carries the rocker. However, it can also be provided that the driver be a mass that is displaced back and forth under the control of a sensor for the natural oscillation of the rocker, so as to thereby maintain a rocking motion of the rocker to which the device is fastened.

### BRIEF DESCRIPTION OF THE DRAWINGS

The invention will be described in more detail below based upon exemplary embodiments. Shown on:

FIG. 1 is a first functional position of a rocker 1 and a driving device 5, in which the rocker 1 lies in an equilibrium position,

FIG. 2 is an illustration according to FIG. 1, wherein the rocker 1 has been swiveled counterclockwise in such a way that its arm 2 touches an impact surface 7 of the head 6,

FIG. 3 is a follow-up illustration to FIG. 2, according to which the arm 2 has been downwardly displaced to such an extent that the head 6 has been displaced into its lower end position,

FIG. 4 is another functional position according to which the head 6 has been upwardly accelerated, the arm 2 has detached itself from the head 6, and the rocker 1 has reached its final swiveling position, in which the previous upward movement of the arm 2 changes into a downward movement of the arm 2,

FIG. 5 in the illustration of a cut through the device 5, is the drive mechanism arranged in the device in a lower end position of the head 6 or a driver 10,

FIG. 6 is an illustration according to FIG. 5, but in the upper end position of the head 6 or the driver 10,

FIG. 7 is an illustration according to FIG. 6, in which the spring element 17 is a pressure spring and the damping element 16 is on a step of the plunger comprising the driver 10.

### DESCRIPTION OF THE EMBODIMENTS

The driving device 5 shown on the drawings has the property of driving a rocker 1, in particular a baby rocker, baby shell, baby seat or the like, synchronously to its free natural oscillation. For a respective short time, the driving device 5 resupplies the power in pulses that the rocker 1 loses to the environment during an oscillation period through friction. The lifting movement of a head 6 that is displaceable relative to a housing 8 is itself here synchronized with the free oscillation of the rocker 1 by way of a driver 10. In the exemplary embodiment, the rocker is illustrated as a baby shell. However, it can also be realized in particular for receiving an infant by means of a baby seat or another swingable system.

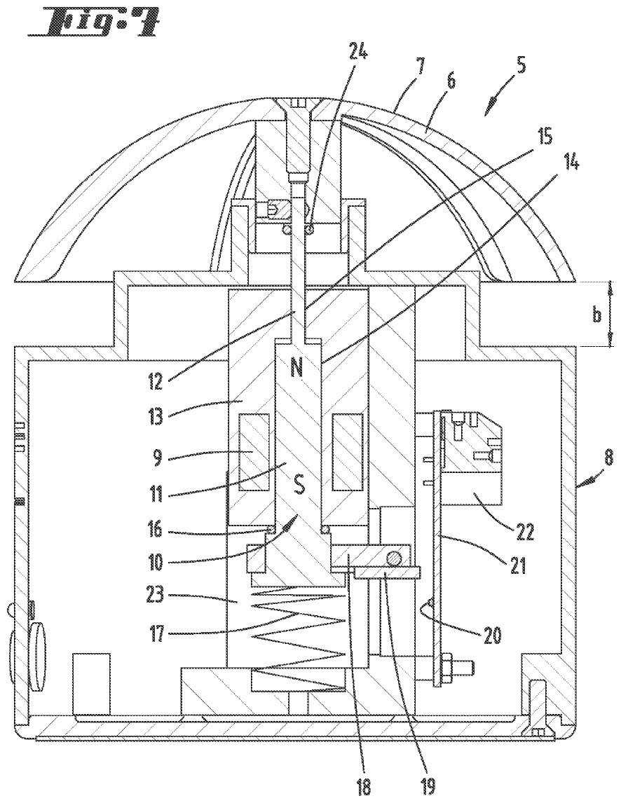

In the exemplary embodiment, the rocker 1 is shaped like a trough with an arm 2 that protrudes on one side. The driving device 5 is arranged under the arm 2 in such a way that an impact surface 7 of the mushroom-shaped head 6 has a segment a from the arm 2 of the rocker 1, and the head 6 assumes an upper end position shown on FIG. 6.

A driver 10 is mounted inside of the housing 8 so that it can move between an upper and a lower end position. In its upper end position, the driver 10 is supported against a damping element 16 in the form of an O-ring. The driver 10 has an oblong shape, and comprises a first magnet 11 whose pole direction points in a vertical direction, i.e., the displacement direction of the driver 10.

The upper end of the driver 10 is comprised of a plunger 12, which is guided in a borehole 15 of a bracket 13 fixedly connected with the housing 8. In addition, the bracket 13 has a guide channel 14 through which the first magnet 11 can run.

The hood-shaped head 6 with its impact surface 7 running on a spherical surface section is connected with the free end of the plunger 12 in its center.

The driver 10 carries a trigger that is formed by a second magnet 19. A carrier 18 that protrudes transversely from the driver 10 in the exemplary embodiment from the lower end of the driver 10 carries the second magnet 19.

A spring element 17, in the exemplary embodiment a tension spring, is provided that acts on the driver 10, so as to hold the driver 10 in the upper end position.

The second magnet 19 has a pole direction that runs parallel to the direction of movement of the driver 10, i.e., extends in the vertical direction.

A sensor 20 is secured to a printed circuit board 21. The sensor 20 is a magnetic sensor, in particular a Hall sensor. It lies at the edge of the movement path of the driver 10 or the trigger (second magnet 19).

An electric circuit 22 is provided, which involves a microcontroller circuit or a microcomputer circuit that can be programmed. Implemented in this circuit 22 is a program, which, controlled by the sensor 20, energizes an electromagnet, which has the function of a power feeder 9 for the driver 10.

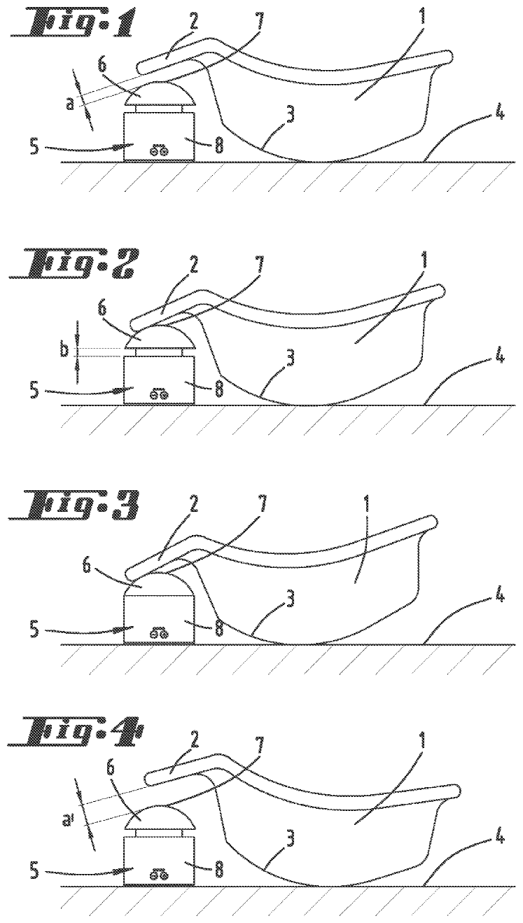

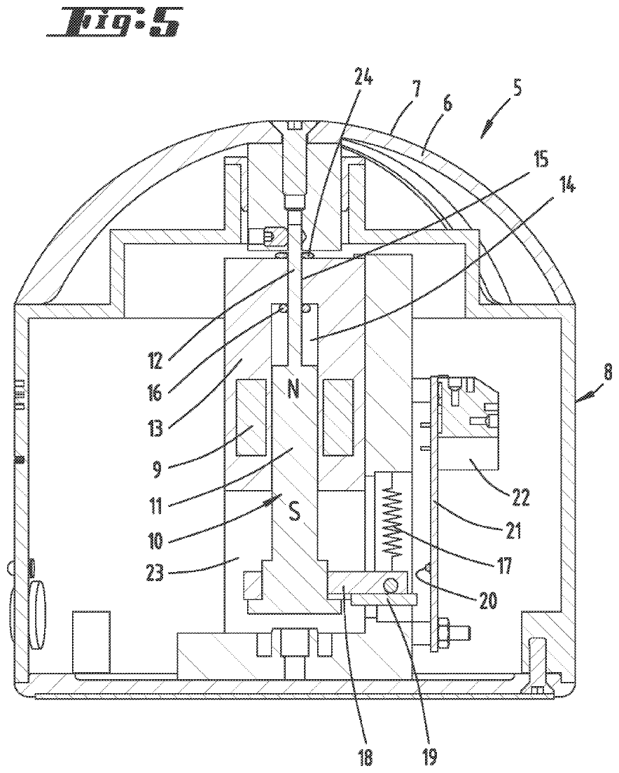

If the rocker 1 is manually pivoted counterclockwise proceeding from the position shown on FIG. 1, for example, its arm 2 impacts the impact surface 7 of the head 6 after a segment a until the intermediate position shown on FIG. 2 has been reached. Continuing to manually pivot the rocker 1 allows the head 6 to be lowered by segment b, wherein the head 6 here changes from the depicted operating position into the operating position shown on FIG. 5. Upon reaching the lower end position of the head 6, a damping element 24 hits against an upper section of the bracket 13.

During this downward displacement of the driver 10, the second magnet 19 overruns the sensor 20 in a downward direction. The magnetic field generated by the second magnet 19 at the site of the sensor 20 can here change its pole direction to counterclockwise. This is detected by the circuit 22 as a downward displacement of the driver 10.

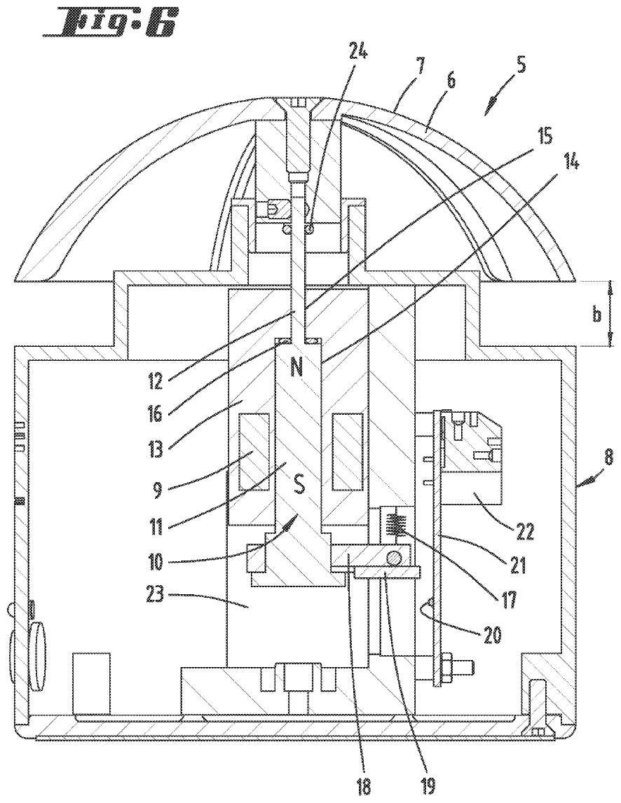

If the head 6 is released from the operating position depicted on FIG. 5, the spring element 17 accelerates the driver 10 in a vertically upward direction. Proceeding from the position shown on FIG. 3, the impact surface 7 here follows the upward movement of the arm 2, until the second magnet 19 passes the sensor 20. The polarity of the magnetic field here changes at the site of the sensor 20 to clockwise, which the circuit 22 interprets as an upward movement of the driver 10. Along with this, the electromagnet that forms the power feeder 9 is energized, so that a supplementary force is exerted on the first magnet 11 in the upward direction. The force is applied for a specific time, in particular until such time that the driver 10 has reached its upper end position shown on FIG. 6. During this movement phase of the driver 10, the power feeder 9 transmits a pulse to the driver 10. It has an accelerating effect on the rocker 1. After reaching the upper end position, the arm 2 leaves the impact surface 7 of the head 6, and after a segment a′ that is larger than segment a reaches the upper dead point depicted on FIG. 4.

In a second period, the rocker 1 swings back, reaches the intermediate position of the maximum angular velocity depicted on FIG. 1, and finally reaches the lower dead point position depicted on FIG. 3, in which the device 5 assumes the operating position shown on FIG. 5. The periodic rocking process then continues in the manner described above.

The exemplary embodiment shown on FIG. 7 essentially corresponds to the exemplary embodiment shown on FIGS. 5 and 6. The spring element that acts on the driver 10 is here a pressure spring, which is supported at its lower end against the housing, and at its upper end against a lower side of the driver 10.

Reference number 23 denotes an energy storage system, e.g., a battery, an accumulator, or a capacitor, which can be electrically charged by an external power supply.

The term rocker cited in the specification comprises all swingable systems which can be made to swing with a device of the described and claimed kind, or in which an oscillation can be maintained for a longer time with the device, once initiated.

The above statements serve to explain the inventions covered by the application as a whole, which each also independently advance the prior art at least by the following feature combinations, wherein two, several or all of these feature combinations can also be combined, specifically:

A device, characterized in that the movement of the driver 10 is clocked by the sensor signal.

A device, characterized in that the rocker 1 is driven with the frequency of its free oscillation.

A device, characterized in that the sensor signal corresponds to a position and/or a direction of movement of the driver 10 on its movement path, wherein it is provided in particular that the sensor 20 emit the sensor signal once the moving driver 10 has reached a predetermined point on its movement path or passed it by.

A device, characterized by a lift or push head 6 that acts on the rocker 1, which is connected with the driver 10 and in particular transmits a vertical lift to the rocker 1, wherein it is provided in particular that the lift or push head 6 is shaped like a mushroom, and sits on a cylindrical housing 8.

A device, characterized in that the power feeder 9 transmits a pulse to the driver 10 only shortly after the sensor signal has been emitted, wherein it is provided in particular that the driver 10 performs a vertical movement, generates a first sensor signal during a downward displacement while being displaced past the sensor 20, and generates a second sensor signal during a subsequent upward displacement while being displaced past the sensor 20, wherein only the second sensor signal triggers the emission of the pulse, wherein additional pulses 10 are only transmitted to the driver during the respective upward displacement.

A device, characterized in that the driver 10 moving in a vertical direction has a mass that is acted upon by a spring element 17, in particular one that is suspended on a spring, wherein this mass can be displaced by applying an external, vertical force in such a way that the sensor 20 triggers a sensor signal.

A device, characterized in that the driver 10 has a first, in particular permanent magnet 11, which is exposed to a force from an electromagnet formed by the power feeder 9 in order to generate the pulse.

A device, characterized in that the sensor 20 is a magnet secured to the housing 8, in particular a Hall sensor, which interacts with a second magnet 19 secured to the driver 10, which in particular is secured to the driver 10 in such a way that the control circuit 22 detects the direction of movement of the driver 10 from a change in the magnetic field, and in particular from a pool change of the magnetic field in the sensor 20.

A device, characterized in that the lift or push head 6 has a mushroom shaped design, and sits on a cylindrical housing 8.

A method, characterized in that the control circuit 22 clocks the movement of the driver 10 with the sensor signal, so that the rocker 1 is driven with a frequency of its free oscillation.

All disclosed features (whether taken separately or in combination with each other) are essential to the invention. The disclosure of the application hereby also incorporates the disclosure content of the accompanying/attached priority documents (copy of the prior application) in its entirety, also for the purpose of including features of these documents in claims of the present application. Even without the features of a referenced claim, the subclaims characterize standalone inventive further developments of prior art with their features, in particular so as to submit partial applications based upon these claims. The invention indicated in each claim can additionally have one or several of the features indicated in the above description, in particular those provided with reference numbers and/or indicated on the reference list. The invention also relates to design forms in which individual features specified in the above description are not realized, in particular if they are recognizably superfluous with regard to the respective intended use, or can be replaced by other technically equivalent means.

Reference List

| | |
|---|---|
| 1 | Rocker |
| 2 | Arm |
| 3 | Runner |
| 4 | Substrate |
| 5 | Driving device |
| 6 | Lift or push head |
| 7 | Impact surface |
| 8 | Housing |
| 9 | Power feeder |
| 10 | Driver |
| 11 | First magnet |
| 12 | Plunger |
| 13 | Bracket |
| 14 | Guide channel |
| 15 | Borehole |
| 16 | Damping element |
| 17 | Spring element |
| 18 | Carrier |
| 19 | Second magnet |
| 20 | Sensor |
| 21 | Printed circuit board |
| 22 | Control circuit |
| 23 | Energy storage system |
| 24 | Damping element |
| a | Distance, segment |
| a′ | Segment |
| b | Segment |

1. A device for generating a rocking movement on a rocker (1), in particular a baby rocker,
comprising a power feeder (9) and a driver (10) that is configured to be moved by the power feeder (9),
and drives the rocker (1) in a repeating movement,
a sensor (20) configured for determining a sensor signal that is influenced by the movement state of the rocker (1), and
a control circuit (22) configured for controlling the power feeder (9) as a function of the sensor signal,
wherein the movement of the driver (10) is clocked by the sensor signal, and the device is suitable for driving the rocker (1) with a frequency of its free oscillation, wherein the power feeder (9) is configured to transmit a pulse to the driver (10) only shortly after the sensor signal has been emitted, wherein the driver (10) is configured to perform a vertical movement, generate a first sensor signal during a downward displacement while being displaced past the sensor (20), and generate a second sensor signal during a subsequent upward displacement while being displaced past the sensor (20), wherein only the second sensor signal triggers the emission of the pulse, and wherein additional pulses are only transmitted to the driver (10) during the respective upward displacement.

2. (canceled)

3. The device according to claim 1, wherein the sensor signal corresponds to a position and/or a direction of movement of the driver (10) on its movement path, wherein the sensor (20) emits the sensor signal once the moving driver (10) has reached a predetermined point on its movement path or passed it by.

4. The device according to claim 1, further comprising a lift or push head (6) that acts on the rocker (1), which is connected with the driver (10) and in particular transmits a vertical lift to the rocker (1), wherein the lift or push head (6) is shaped like a mushroom, and sits on a cylindrical housing (8).

5. (canceled)

6. The device according to claim 1, wherein the driver (10) moving in a vertical direction has a mass that is acted upon by a spring element (17) is suspended on a spring, wherein this mass can be displaced by applying an external, vertical force in such a way that the sensor (20) triggers a sensor signal.

7. The device according to claim 1, wherein the driver (10) has a first, permanent magnet (11), which is exposed to a force from an electromagnet formed by the power feeder (9) in order to generate the pulse.

8. The device according to claim 1, wherein the sensor (20) is a magnet secured to the housing (8), in particular a Hall sensor, which interacts with a second magnet (19) secured to the driver (10), which is secured to the driver (10) in such a way that the control circuit (22) detects the direction of movement of the driver (10) from a change in the magnetic field, and in particular from a pole change of the magnetic field in the sensor (20).

9. A method for generating a rocking movement on a rocker (1), in particular a baby rocker, with a driver (10) that can be moved by a power feeder (9), and drives the rocker (1) in a repeating movement, wherein a sensor (20) determines a sensor signal that is influenced by the movement state of the rocker (1), and a control circuit (22) controls the power feeder (9) as a function of the sensor signal, wherein the control circuit (22) clocks the movement of the driver (10) with the sensor signal, so that the rocker (1) is driven with a frequency of its free oscillation, wherein the power feeder (9) transmits a pulse to the driver (10) only shortly after the sensor signal has been emitted, wherein the driver (10) performs a vertical movement, generates a first sensor signal during a downward displacement while being displaced past the sensor (20), and generates a second sensor signal during a subsequent upward displacement while being displaced past the sensor (20), wherein only the second sensor signal triggers the emission of the pulse, and wherein additional pulses are only transmitted to the driver (10) during the respective upward displacement.

10. (canceled)
